(19) United States
(12) Patent Application Publication
(10) Pub. No.: US 2012/0228909 A1
(43) Pub. Date: Sep. 13, 2012

(54) VEHICULAR SEAT SYSTEM AND METHOD FOR USING THEREOF

(76) Inventor: HAMRAM BLAU, Jerusalem (IL)

(21) Appl. No.: 13/409,140

(22) Filed: Mar. 1, 2012

(30) Foreign Application Priority Data
Mar. 8, 2011 (IL) 211617

(51) Int. Cl. B60N 2/26

(52) U.S. Cl. 297/238

(57) ABSTRACT

A vehicular seat system (11) comprising: a vehicular seat (16) comprising an openable compartment (44) within the backrest (14) thereof; and an inflatable child safety seat (10) housed in the deflated state thereof inside the compartment (44), thereby saving volume in the vehicle.

### FIELD OF THE INVENTION

The present invention relates to the field of child safety seats. More particularly, the invention relates to a method and apparatus for using a child safety seat within the vehicle.

### BACKGROUND OF THE INVENTION

Vehicular child safety seats are seats designed specifically to protect children from injury or death during collisions.

However, these seats occupy a large volume in the vehicle, which cannot be utilized else than by a child.

U.S. Pat. No. 4,711,490 discloses a seat for supporting a child or infant for use in an automobile which is composed of pliable fabric arranged in a unitized or integral manner to define a seat, arm rests, back and front tray or bar. The fabric provides conduits or channels of continuous passages for holding air when pressurized.

However, this seat does not provide integration of the child safety seat into the vehicle's design.

All the methods described above have not yet provided satisfactory solutions to the long felt need of a child safety seat which may be integrated into the vehicle's design.

It is an object of the present invention to integrate a child safety seat directly into the vehicle's design

It is an object of the present invention to provide a solution to the above-mentioned and other problems of the prior art.

Other objects and advantages of the invention will become apparent as the description proceeds.

### SUMMARY OF THE INVENTION

In the figures and/or description herein, the following reference numerals have been mentioned:
numeral 10 denotes a child safety seat according to one embodiment of the present invention;
numeral 11 denotes a child safety system according to one embodiment of the present invention; numeral 12 denotes a cover of a backrest;
numeral 14 denotes a backrest;
numeral 16 denotes a vehicular seat;
numeral 18 denotes an air outlet;
numeral 20 denotes a belt for securing the child to the child safety seat;
numeral 22 denotes a belt for securing the child safety seat to the vehicular seat;
numeral 24 denotes an air inlet;
numeral 26 denotes a perforation;
numeral 28 denotes filled air and air flow;
numeral 30 denotes a pump powered by the vehicle;
numeral 32 denotes an external inflatable tank;
numeral 34 denotes an internal inflatable tank;
numeral 36 denotes a side board;
numeral 38 denotes a track for moving the side board;
numeral 40 denotes a base of the child safety seat for sitting thereon;
numeral 42 illustrates another size of the base of the child safety seat;
numeral 44 denotes a compartment for housing the child safety seat when deflated; and
numeral 46 denotes the front of the backrest; and
numeral 48 denotes a base of the vehicular seat for sitting thereon.

In one aspect, the present invention is directed to a vehicular seat system (11) comprising:
a vehicular seat (16) comprising an openable compartment (44) within the backrest (14) thereof, and
an inflatable child safety seat (10) housed in the deflated state thereof inside the compartment (44),
   thereby saving volume in the vehicle.

The compartment (44) may comprise:
a non-openable surface (46) at the front of the backrest (14); and
an openable cover (12) at the rear of the backrest (14), for covering the inflatable seat (10) upon the housing, and for opening the compartment (44) upon inflation of the inflatable seat (10),
   thereby the non-openable surface (46) provides comfortable leaning on the backrest (14) for using the vehicular seat (16).

According to one embodiment, the child safety seat (10 is permanently attached to the vehicular seat backrest (14), thereby the child safety seat (10) does not require fastening thereof to the vehicular seat (16) at the inflated state.

According to this embodiment, the child safety seat (10) may be disposed at the back of the vehicular seat (16) in the inflated state thereof.

The child safety seat (10) may be slightly inflated at the deflated state thereof,

thereby providing the softness of the backrest (14) required for a person resting on the backrest (14).

According to another embodiment, the child safety seat (10) may be removable from the compartment (44) for being disposed on a base (48) of a vehicular seat (16).

The vehicular child safety system (11) may further comprise:
an air pump (30) powered by the vehicle.

The child safety seat (10) may comprise perforations (26) for ventilating the child sitting on the seat (10).

In another aspect, the present invention is directed to a method for using a vehicular child safety seat (10), the method comprising the steps of:
providing a compartment (44) within a vehicular seat (16);
providing an inflatable child safety seat (10);
housing the inflatable seat (10) in the deflated state thereof inside the compartment (44); and
inflating the child safety seat (10), to be attached to the backrest (14),
   thereby saving volume in the vehicle.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 depicts a child car seat system according to one embodiment of the present invention.

FIG. 2 depicts the child car seat of FIG. 1 being deflated.

FIG. 3 depicts the vehicular seat upon full deflation of the child safety seat of FIG. 1.

FIG. 4 depicts a child car seat according to another embodiment of the present invention.

FIG. 5 is a side sectional view of the air seat of FIG. 1.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, s_{y}stems, procedures, components, circuits, and so on, are not described in detail.

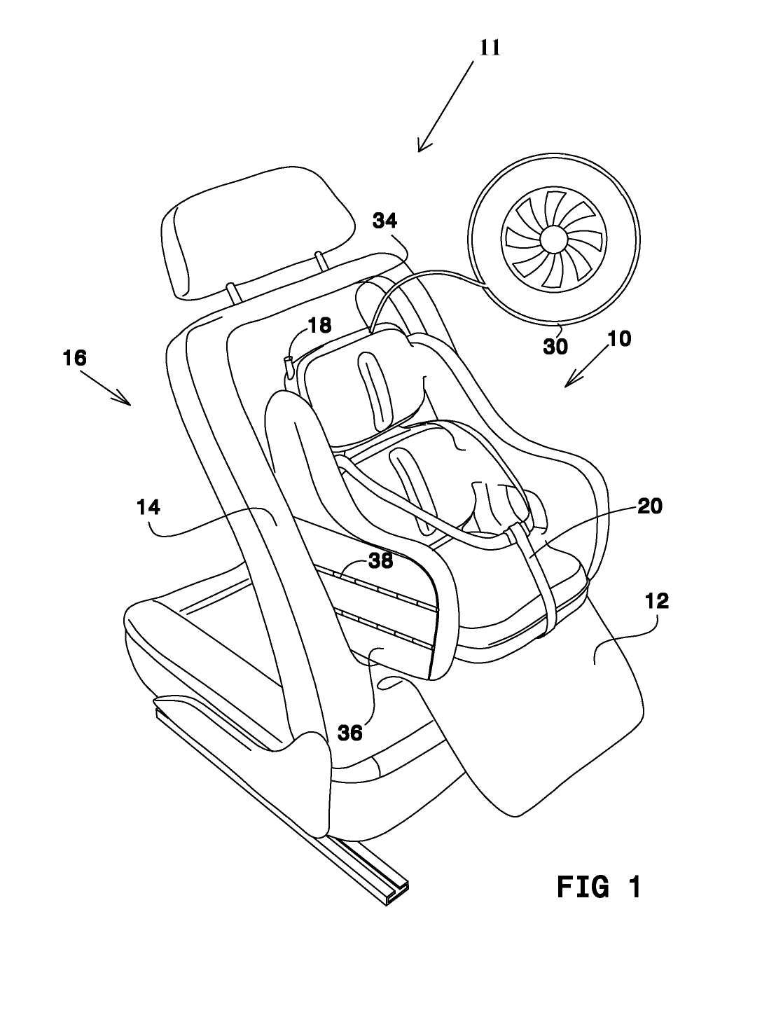

FIG. 1 depicts a child car seat system, according to one embodiment of the present invention.

A child car seat system 11 includes a child safety seat 10 housed in a back rest 14 of a vehicular seat 16. According to one embodiment, the attachment of child safety seat 10 to vehicular seat 16 is permanent.

Child safety seat 10 is inflatable, for instance, via an is inlet 24, and by a pump 30 powered by the vehicle, and deflated via an outlet 18. Upon being inflated, it acquires the form of a seat.

Vehicular seat 16 may include additional accessories such as side boards 36 for securing the child, and tracks 38 for moving boards 36. The child safety seat includes belts 20, for securing the child to child safety seat 10.

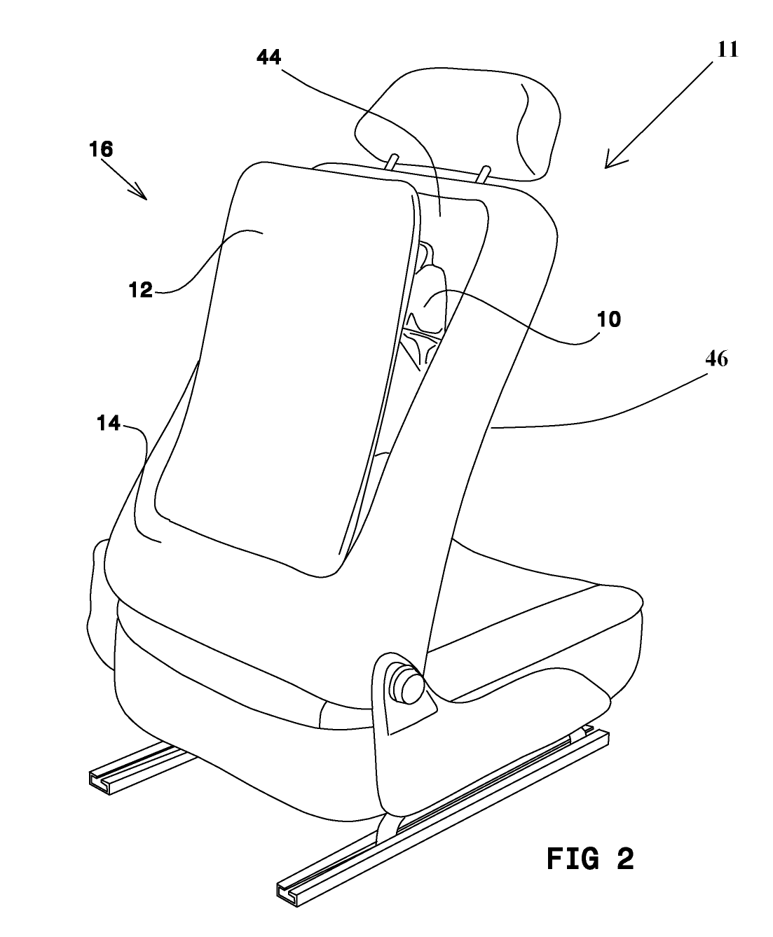

FIG. 2 depicts the child car seat of FIG. 1 being deflated.

A cover 12, which may be an inherent element of vehicular seat 16 may cover child safety seat 10, upon deflation. The front 46 of vehicular seat 16 is not openable, and thus may include the elements for providing leaning on the vehicular backrest.

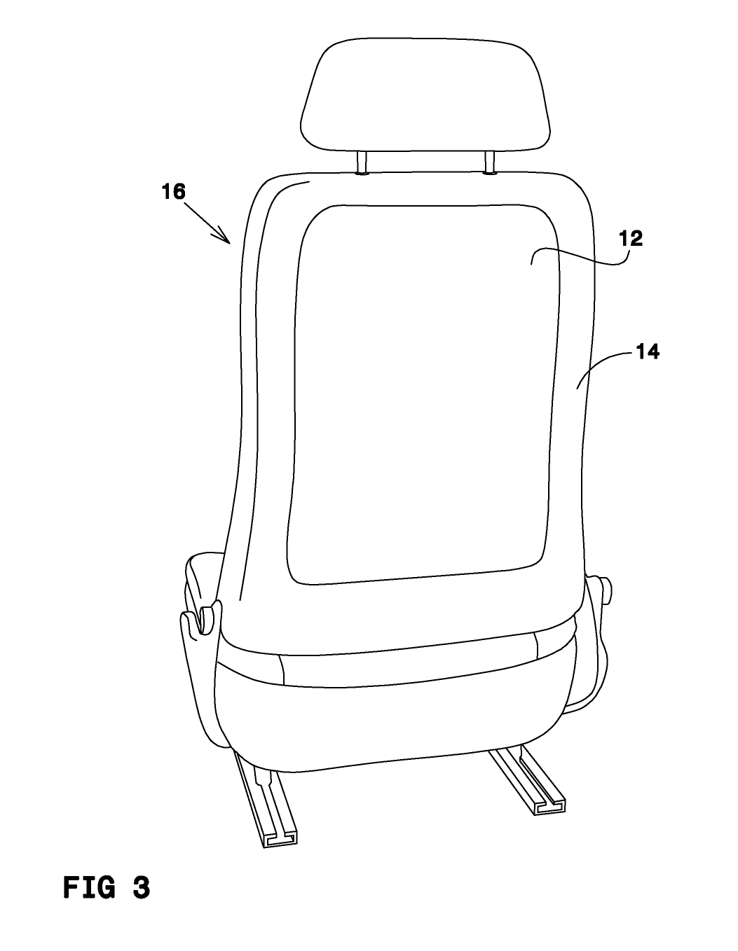

FIG. 3 depicts the vehicular seat upon full deflation of the child safety seat of FIG. 1.

Child car seat 10 is housed deflated inside a compartment 44 formed between cover 12 of backrest 14 of vehicular seat 16, and the front of backrest 14.

Child safety seat 10 may contain a small volume of air, even upon deflation. for providing the softness required for the adult resting on backrest 14.

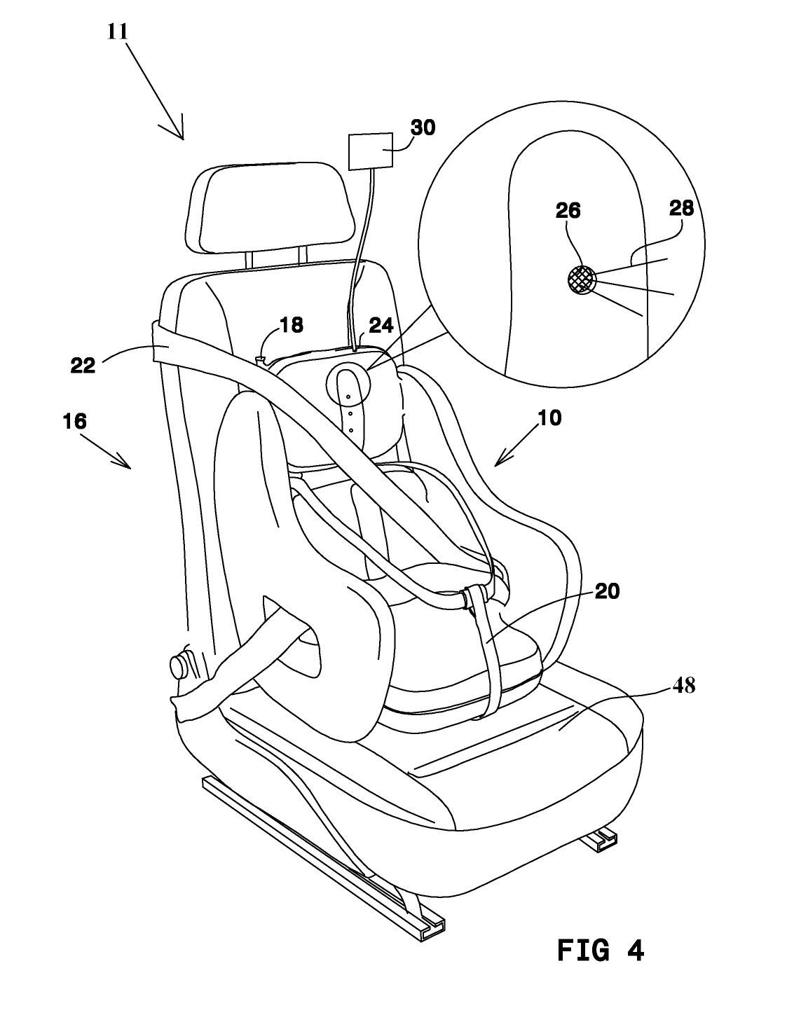

FIG. 4 depicts a child car seat according to another embodiment of the present invention.

According to another embodiment, child safety seat 10 is only housed deflated inside compartment 44, as depicted in FIGS. 2 and 3 and elsewhere. After removing child safety seat 10 from compartment 44 and inflating it, it is placed on a base 48 of vehicular seat 16, thus at the front of backrest 16.

According to this embodiment, child safety seat 10 is attached to vehicular seat 16 by belts 22 of the vehicle similar to prior art child safety seats.

Pump 30 may provide air flow 28 through perforations 26, for ventilating the child against moist.

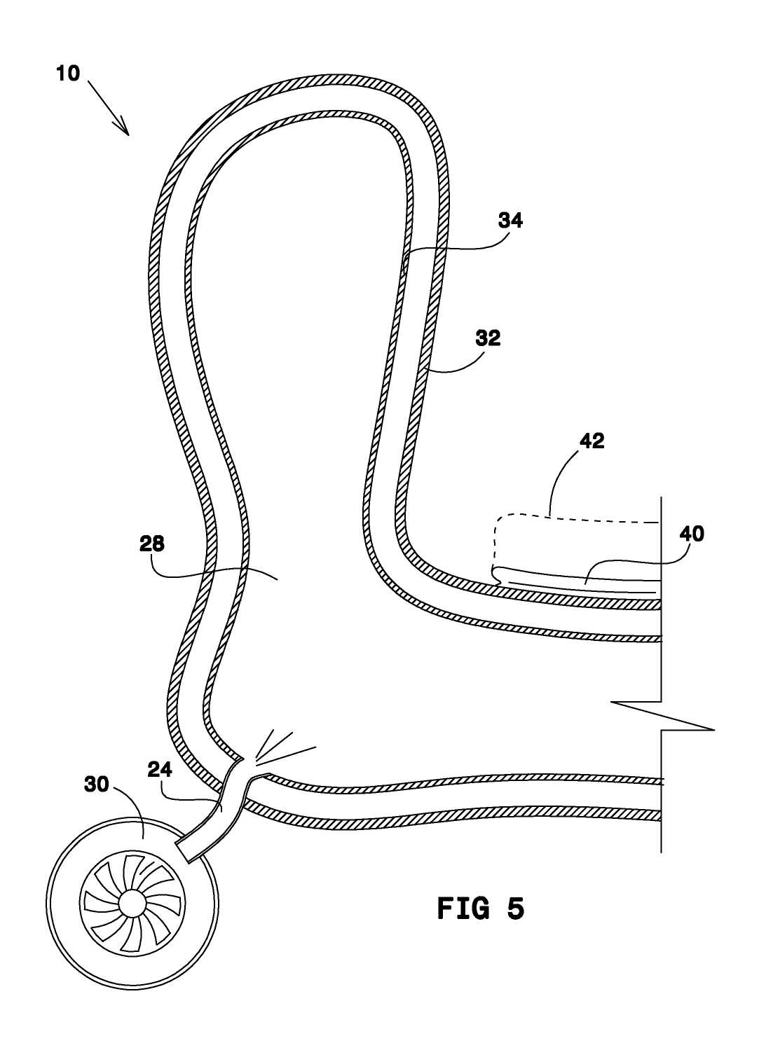

FIG. 5 is a side sectional view of the air seat of FIG. 1.

Air seat 10 may include an external inflatable tank 32 and an internal inflatable tank 34. Thus, puncturing of external tank 32 does not endanger the child.

According to one embodiment, the height of the base 40 of child safety seat 10 or other elements thereof may be adjusted to a size 42, for adapting child safety seat 10 to the actual size of the child.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A vehicular seat system (11) comprising:
a vehicular seat (16) comprising an openable compartment (44) within the backrest (14) thereof; and
an inflatable child safety seat (10) housed at the deflated state thereof inside said compartment (44),
thereby saving volume in said vehicle.

2. A vehicular child safety system (11) according to claim 1, wherein said compartment (44) comprises:
a non-openable surface (46) at the front of said backrest (14); and
an openable cover (12) at the rear of said backrest (14), for covering said inflatable seat (10) upon said housing, and for opening said compartment (44) upon inflation of said inflatable seat (10),
thereby said non-openable surface (46) provides comfortable leaning on said backrest (14) for using said vehicular seat (16).

3. A vehicular child safety system (11) according to claim 1, wherein said child safety seat (10 is permanently attached to said vehicular seat backrest (14),
thereby said child safety seat (10) does not require fastening thereof to said vehicular seat (16) at the inflated state.

4. A vehicular child safety system (11) according to claim 3, wherein said child safety seat (10) is disposed at the back of said vehicular seat (16) at the inflated state thereof.

5. A vehicular child safety system (11) according to claim 2, wherein said child safety seat (10) is slightly inflated at the deflated state thereof,
thereby providing softness of said backrest (14) required for a person resting on said backrest (14).

6. A vehicular child safety system (11) according to claim 1, wherein said child safety seat (10) is removable from said compartment (44) for being disposed on a base (48) of a vehicular seat (16).

7. A vehicular child safety system (11) according to claim 1, further comprising:
an air pump (30) powered by said vehicle.

8. A vehicular child safety system (11) according to claim 6, wherein said child safety seat (10) comprises perforations (26) for ventilating the child sitting on said seat (10).

9. A method for using a vehicular seat (16), said method comprising the steps of
providing a compartment (44) within a vehicular seat (16);
providing an inflatable child safety seat (10);
housing and attaching said inflatable seat (10) in the deflated state thereof inside said compartment (44); and
inflating said child safety seat (10), yet being attached to said backrest (14),
thereby saving volume in said vehicle.
